(19) United States
(12) Patent Application Publication
(10) Pub. No.: US 2007/0000141 A1
(43) Pub. Date: Jan. 4, 2007

(54) Film cutter

(76) Inventors: Terrance M. Deshotel, Callander (CA); John R. Deshotel, Sour Lake, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/473,628

(22) Filed: Jun. 23, 2006

Related U.S. Application Data
(60) Provisional application No. 60/649,878, filed on Jun. 30, 2005.

(51) Int. Cl. B43L 7/00

(52) U.S. Cl. 33/484

(57) ABSTRACT

Provided herein is a sheet material cutting apparatus having a cutter with a cutting surface; a cutting surface guard disposed about the cutting surface of the cutter; and a cutting table disposed about the cutting surface of the cutter. The cutting surface guard further has an opening for receiving the sheet material. The cutting table further has a receiving surface for receiving the sheet material for cutting. The cutting table further has a spacer hole for receiving the cutting surface of the cutter, preventing the cutting surface of the cutter from contacting objects not received by the receiving surface of the cutting table. The spacer hole of the cutting table further has a hole there through the cutting table, preventing accumulation of matter within the spacer hole. The cutter is disposed on an upright mobility device, providing control of the apparatus from a position elevated from the cutting elevation.

### STATEMENT OF RELATED CASES

This application claims the benefit of United States Provisional Application No. 60/649,878, of filing date Jun. 30th, 2005.

### FIELD OF THE INVENTION

The present invention relates generally to sheet material cutters and, more specifically, to selectively cutting liner sheets.

### BACKGROUND OF THE INVENTION

The present invention is drawn to methods and means by which large rolls of plastic or other lightweight materials are cut and laid out for use. In the past, those of ordinary skill in the art have been reduced to cutting plastic liners using more awkward and cumbersome means such as shears or razor blades. Consequently, cutting and arranging the liner (as is required, for example, in numerous lawn and landscaping applications) takes an inordinate amount of time. Breaks in the seals of overlapping liner sections are common due to the rough and irregular manner in which individual large sheets are cut to size.

According to the invention, however, an elevated means of quickly, safely and comfortably cutting the liner sections prior to installation is provided in which the chassis of the device is modeled after a conventional lawn edger, so that the operator can remain standing during operations, thereby ensuring his or her greater comfort as compared to the prior means of cutting a liner using shears or razor blade knives, etc., and the linear or shaped cutting path desired by practitioners is readily achieved.

### SUMMARY OF THE INVENTION

According to a first set of examples of the invention, there is provided a sheet material cutting apparatus having a cutter and a cutting surface; a cutting surface guard disposed about the cutting surface of the cutter; and a cutting table disposed about the cutting surface of the cutter. The cutting surface guard further has an opening for receiving the sheet material. The cutting table further has a receiving surface for receiving the sheet material for cutting. The cutting table further has a spacer hole for receiving the cutting surface of the cutter, preventing the cutting surface of the cutter from contacting objects not received by the receiving surface of the cutting table. The spacer hole of the cutting table further has a hole there through the cutting table, preventing accumulation of matter within the spacer hole.

According to another example of the invention, the cutting guard and the cutting table of the above-described sheet material cutting apparatus are integrated into a single component disposed about the cutting surface of the cutter.

According to another example of the invention, the above-described sheet material cutting apparatus further has a cut piece separator disposed between the cutting table and the cutting surface guard.

According to another example of the invention, the cutting guard and the cutting table and the cut piece separator of the above-described sheet material cutting apparatus are integrated into a single component disposed about the cutting surface of the cutter.

According to another example of the invention, the above-described sheet material cutting apparatus further has a second cutter laterally displaced from the first cutter.

In relation to this example, the above-described sheet material cutting apparatus is used to remove seams from the sheet material.

According to another example of the invention, the above-described sheet material cutting apparatus further has an upright mobility device wherein the cutter is disposed on the upright mobility device.

According to another example of the invention, the upright mobility device of the above-described sheet material cutting apparatus further has a carriage for accommodating the cutter; a pair of axially aligned rearward wheels which are axially rotatably connected to the carriage and at least one forward wheel that is swivelably and rotatably mounted to the carriage, each wheel being rotatably engagable with the surface of the sheet material; the carriage including a support frame for accepting the cutter; a handle attached to and extending rearwardly from the frame, whereby applying a generally horizontal pushing or pulling force to the handle causes the upright mobility device to move over the sheet material on the wheels while the cutter and the cutting table are maintained in a generally engaged condition with respect to the sheet material; at least one of the wheels being carried by a strut that is connected to the frame, the strut being alternatable between an open condition wherein the wheel attached to the strut is deployed for moving on the sheet material and a collapsed condition wherein the wheel attached to the strut is retracted for storage of the mobility device; and a hand switch to control operation of the cutter.

According to another example of the invention, the above-described sheet material cutting apparatus further has a cut line indicator disposed on the upright mobility device.

In relation to these examples, the above-described sheet material cutting apparatus is used to cut culvert liners.

In relation to these examples, the above-described sheet material cutting apparatus is used to cut stud liners.

In relation to these examples, the above-described sheet material cutting apparatus is used to cut a material selected from the group of materials consisting essentially of: plastic sheets, cardboard, corrugated board, tarps, metal sheets, and stud liner sheets.

According to a second set of examples of the invention, there is provided a method for cutting sheet material comprising the steps of: selectively receiving the sheet material to be cut, the selective receiving step comprising a guard means to restrict receipt of undesired objects; tabling the sheet material received, the tabling step comprising a biasing means to prevent cutting of objects not selectively received; cutting the sheet material received into at least two components; and laterally displacing the at least two components of the sheet material.

According to another example of the invention, the cutting step of the above-described method for cutting sheet material comprises cutting the sheet material received along two substantially parallel lines, cutting the sheet material into three components.

In relation to these examples, the above-described method for cutting sheet material is used to remove seams from the sheet material.

According to another example of the invention, the above-described method for cutting sheet material further comprises the steps of: disposing the cutting step near the elevation of the sheet material to be cut; and operating and directing the cutting step from a position elevated from the elevation of the sheet material to be cut.

In relation to these examples, the above-described method for cutting sheet material is used to cut culvert liners.

In relation to these examples, the above-described method for cutting sheet material is used to cut stud liners.

In relation to these examples, the above-described method for cutting sheet material is used to cut a material selected from the group of materials consisting essentially of: plastic sheets, cardboard, corrugated board, tarps, metal sheets, and stud liner sheets.

According to a third set of examples of the invention, there is provided a system for cutting sheet material having: a means for cutting the sheet material; a means for guarding access to the cutting surface, disposed about the cutting surface; a means for tabling the sheet material, disposed about the cutting surface of the cutting means; and a means for separating pieces cut from the sheet material, the separating means having a surface for laterally displacing the pieces of the cut material. The cutting means has a cutting surface. The guarding means has an opening for receiving the sheet material. The tabling means has a surface for receiving the material for cutting. The surface of the tabling means has a spacer hole preventing contact of the cutting surface of the cutting means with objects not received by the tabling means. The spacer hole is a hole there through, preventing accumulation of matter within the spacer hole.

According to another example of the invention, the above-described system for cutting sheet material further has a second means for cutting the sheet material, laterally displaced from the first cutting means.

In relation to these examples, the above-described system for cutting sheet material is used to remove seams from the sheet material.

According to another example of the invention, the above-described system for cutting sheet material further has a means to indicate a cut line.

According to another example of the invention, the above-described system for cutting sheet material further has a means to dispose the cutting means near the elevation of the sheet material to be cut; and a means to operate and direct movement of the system from a position elevated from the elevation of the sheet material to be cut.

According to another example of the invention, the disposing means of the above-described system for cutting sheet material has: a carriage means for accommodating the cutting means; and a movable engagement means for moving the cutting means about the surface of the sheet material. Further, the means to operate and direct movement of the system from a position elevated from the elevation of the sheet material to be cut has: a support frame on the carriage means for accepting the cutting means; and a handle means attached to and extending rearwardly from the frame. Applying a generally horizontal pushing or pulling force to the handle means causes the disposing means to move over the sheet material on the movable engagement means while the cutting means and the tabling means are maintained in a generally engaged condition with respect to the sheet material. At least one portion of the movable engagement means is carried by a strut that is connected to the frame. The strut is alternatable between an open condition wherein the movable engagement means attached to the strut is deployed for moving on the sheet material and a collapsed condition wherein the movable engagement means attached to the strut is retracted for storage of the disposing means. The handle means further has a hand switch to control operation of the cutting means.

In relation to these examples, the above-described system for cutting sheet material is used to cut culvert liners.

In relation to these examples, the above-described system for cutting sheet material is used to cut stud liners.

In relation to these examples, the above-described system for cutting sheet material is used to cut a material selected from the group of materials consisting essentially of: plastic sheets, cardboard, corrugated board, tarps, metal sheets, and stud liner sheets.

### BRIEF DESCRIPTION OF THE SEVERAL DRAWINGS

FIG. 1 is a 3-D perspective view of the film cutter with upright mobility device in an open or deployed condition.

FIG. 2 is a 3-D perspective left-side view of the integrated cutting guard, cutting table, and cut piece separator of the present invention.

FIG. 3 is a 3-D perspective right-side view of the integrated cutting guard, cutting table, and cut piece separator of the present invention.

FIG. 4 is a 3-D perspective bottom-side view of the integrated cutting guard, cutting table, and cut piece separator of the present invention.

FIG. 5 is a 3-D perspective view of the film cutter with upright mobility device in a collapsed or retracted condition.

### DETAILED DESCRIPTION

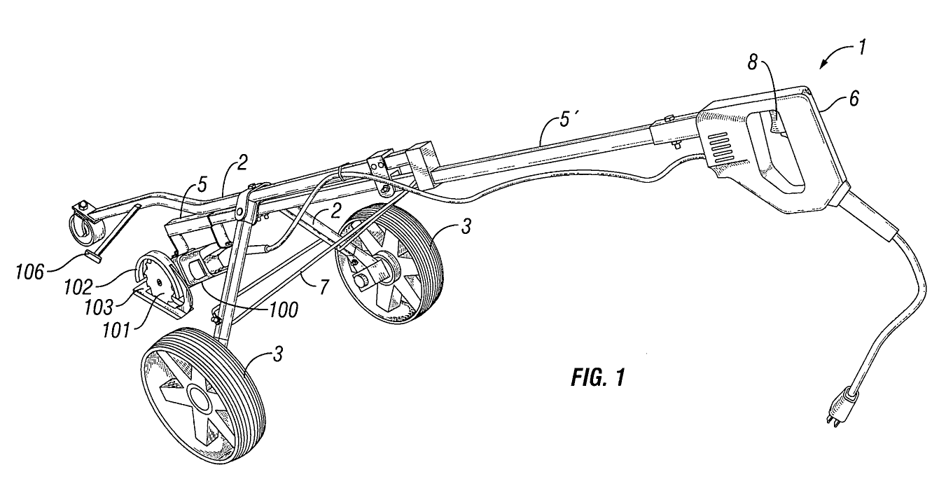

Each of FIGS. 1-5 illustrates a film cutter and sheet cutting system (and method of applying same) embodying various aspects of the present invention. These particular examples are illustrated and described herein for exemplary purposes. Variations of the film cutter and methods of utilizing or installing the same, according to the invention, will become readily apparent to one skilled in the relevant structural or mechanical art upon reading the present Description and/or viewing the accompanying Drawings. Thus, the present invention should not be limited to the structures, systems, and methods described below.

FIG. 1 is a 3-D perspective view of the film cutter 100 with an upright mobility device 1 in an open or deployed condition. Film cutter 100 provides a means for cutting sheet material. Typically, an angle-grinding tool with an adapted blade is used. Typically, the sheet material to be cut is positioned on the ground or floor level. Some forms of sheet material include: plastic sheets, cardboard, corrugated board, tarps, metal sheets, and stud liner sheets.

Upright mobility device 1 provides a means to dispose the cutting means, such as film cutter 100, near the elevation of the sheet material to be cut. Typically, the operator wishes to be able to cut the sheet material from a standing or walking position. Upright mobility device 1 provides a means to so operate and direct movement of the cutting means, such as film cutter 100, from a position elevated from the elevation of the sheet material to be cut.

Upright mobility device 1 has a carriage means, such as carriage 2, for accommodating cutter 100. A pair of axially aligned rearward wheels 3 is axially rotatably connected to carriage 2. A forward wheel 4 is swivelably and rotatably mounted to carriage 2. Rearward wheels 3 and forward wheel 4 are rotatably engagable with the surface of the sheet material, providing an example of a movable engagement means for moving the cutting means about the surface of the sheet material. Carriage 2 includes a support frame 5,5′ for accepting cutter 100.

A cutting surface 101 is attached to cutter 100. Cutting surface 101 is typically a blade adapted for use on an angle-grinding tool. A means is provided for guarding access to cutting surface 101 to reduce chances of accidental cutting of hands or feet. Cutting surface guard 102 is disposed about cutting surface 101 of cutter 100. Materials may be on the ground or floor surface other than the desired sheet or sheets to be cut. These may be other layers of sheets, debris, pipes, wires, or flooring. To separate the desired sheet material to be cut from other materials, a cutting table 103 is disposed about cutting surface 101 of cutter 100, providing a means to table the sheet material to be cut. Typically, cutting table 103 is of some thickness, providing a biasing means, to assist in slightly picking up the sheet material to be cut from the ground or floor surface to cutting surface 101.

Returning to upright mobility device 1, a handle 6 is attached to and extending rearwardly from frame 5,5′. Applying a generally horizontal pushing or pulling force to the handle means, such as handle 6, causes the disposing means, upright mobility device 1, to move over the sheet material on the movable engagement means, such as rearward wheels 3 and forward wheel 4, while the cutting means and the tabling means, such as cutter 100 and cutting table 103, are maintained in a generally engaged condition with respect to the sheet material.

At least one of the movable engagement means, such as rearward wheels 3, are carried by a strut 7 that is connected to frame 5′. Strut 7 is alternatable between an open or deployed condition (as shown in FIG. 1) and a collapsed or retracted condition (as will be shown in FIG. 5). Rearward wheels 3 attached to strut 7 are deployed for moving on the sheet material. Rearward wheels 3 attached to strut 7 are retracted for storage of upright mobility device 1.

Handle 6 includes a hand switch 8 to control operation of the cutting means, such as cutter 100.

A guide may be provided on upright mobility device 1 to assist in orienting cutting surface 101 along the line to be cut on the sheet material, a means to indicate the cut line. One example of providing such an indicating means is to dispose a cut line indicator 106 on upright mobility device 1. Cut line indicator 106 is a bar extending laterally from carriage 2, generally ahead or in front of cutting surface 101. The bar of cut line indicator 106 has a termination or indicating mark at a position approximately equal to the position of cutting surface 101. An operator may use this termination or indicating mark to guide orientation of upright mobility device 1 and corresponding orientation of cutting surface 101.

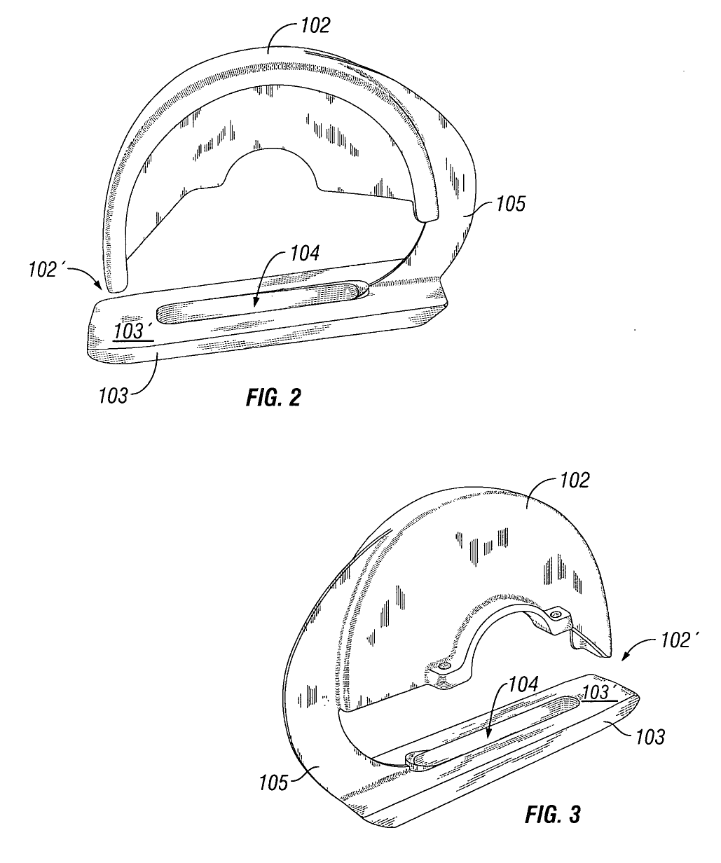

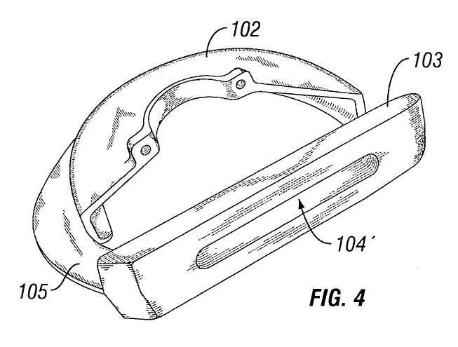

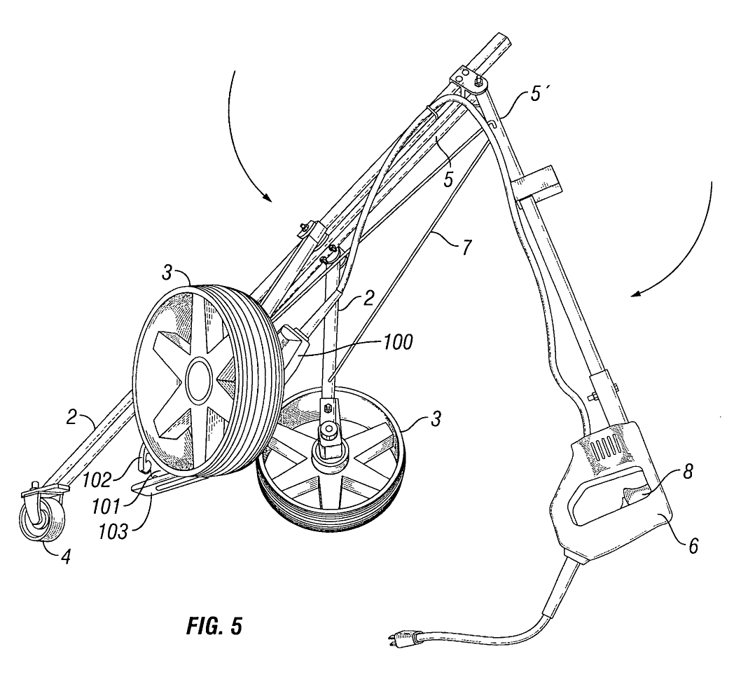

FIG. 2 is a 3-D perspective left-side view of the integrated cutting guard, cutting table, and cut piece separator of the present invention. FIG. 3 is a 3-D perspective right-side view of the integrated cutting guard, cutting table, and cut piece separator of the present invention. FIG. 4 is a 3-D perspective bottom-side view of the integrated cutting guard, cutting table, and cut piece separator of the present invention. FIGS. 2-4 are referenced in the detailed description that follows.

Cutting surface guard 102 further has an opening 102′ for receiving the sheet material. Opening 102′ is typically dimensioned to allow for entry towards cutting surface 101 of the desired sheet material to be cut while also dimensioned to minimize entry towards cutting surface 101 of body parts, such as feet or hands. Cutting table 103 further has a receiving surface 103′ for receiving the sheet material for cutting. Typically, in order for cutting surface 101 to have cutting effect, cutting surface 101 protrudes to some degree above and beneath the sheet material to be cut. Cutting table 103 further has a spacer hole 104 for receiving cutting surface 101 of cutter 100 (illustrated in FIG. 1). Spacer hole 104 provides room for cutting surface 101 to protrude to some degree beneath receiving surface 103′ and beneath the sheet material to be cut. The biasing means or thickness of cutting table 103 provides thickness to accommodate spacer hole 104, preventing cutting surface 101 of cutter 100 from contacting objects not received by receiving surface 103′ of cutting table 103. Thus, cutting surface 101 cuts only the desired sheet or sheets to be cut and does not cut other materials, such as other layers of sheets, debris, pipes, wires, or flooring.

Debris from cutting operations will tend to accumulate in spacer hole 104. Extending spacer hole 104 through to the bottom side of cutting table 103 prevents this. Spacer hole 104 of cutting table 103 further has a hole 104′ there through cutting table 103, preventing accumulation of matter within spacer hole 104.

A cut piece separator 105 is disposed between cutting table 103 and cutting surface guard 102. Cut piece separator 105 provides a means for separating and laterally displacing pieces cut from the sheet material, guiding the cut pieces away from cutting surface 101 to prevent undesired cutting or binding.

FIG. 5 is a 3-D perspective view of the film cutter with upright mobility device in a collapsed or retracted condition. At least one of the movable engagement means, such as rearward wheels 3, are carried by strut 7 that is connected to frame 5′. Strut 7 is alternatable between an open or deployed condition (as was shown in FIG. 1) and a collapsed or retracted condition (as shown here in FIG. 5). Rearward wheels 3 attached to strut 7 are deployed for moving on the sheet material. Rearward wheels 3 attached to strut 7 are retracted for storage of the upright mobility device 1.

A second means for cutting the sheet material may be laterally displaced from cutter 100 (not illustrated). In this configuration, the sheet material is cut along two substantially parallel lines. This cuts the sheet material into three components, the middle component or swath being approximately the width of the lateral distance between the two cutters. Such cutting is useful to remove welded seams from previously laid sheet material.

In operation, the sheet material to be cut is selectively received, with undesired objects restricted by a guard means. The material to be cut is then tabled for cutting. The tabling is typically biased to lift the material to be cut from its ground or floor surface and to prevent cutting of materials not received. The sheet material received is cut into at least two components. The two components are laterally displaced as the cutting proceeds.

The cutting step may be performed near the elevation of the sheet material to be cut, such as near ground or floor level, while operating and directing the cutting step from a position elevated from the elevation of the sheet material to be cut. This enables an operator to stand and walk during the cutting operation.

Using a cut line indicator, an operator may align the direction of cutting to the desired cutting pattern. In operation, the operator visually inspects the cut line indicator against a chalk line, distant marker, or other marking, correcting the direction of cutting to align the cut line indicator to the marking.

Systems and apparatus made according to the present invention may be used to cut sheet material of various compositions. These include, but are not limited to, plastic sheets, cardboard, corrugated board, tarps, metal sheets, and stud liner sheets. In particular, the present invention provides a new and convenient way to cut culvert liners and stud liners in field operation.

Thus, the foregoing description is presented for purposes of illustration and description, and is not intended to limit the invention to the forms disclosed herein. Consequently, variations and modifications commensurate with the above teachings and the teaching of the relevant art are within the spirit of the invention. Such variations will readily suggest themselves to those skilled in the relevant structural or mechanical art. Further, the embodiments described are also intended to explain the best mode for practicing the invention, and to enable others skilled in the art to utilize the invention and such or other embodiments and with various modifications required by the particular applications or uses of the invention. It is intended that the appended claims be construed to include alternative embodiments to the extent that is permitted by prior art.

What is claimed is:

1. A sheet material cutting apparatus comprising:
a cutter having a cutting surface;
a cutting surface guard disposed about said cutting surface of said cutter;
said cutting surface guard further comprising an opening for receiving the sheet material;
a cutting table disposed about said cutting surface of said cutter;
said cutting table further comprising a receiving surface for receiving the sheet material for cutting;
said cutting table further comprising a spacer hole for receiving said cutting surface of said cutter, preventing said cutting surface of said cutter from contacting objects not received by said receiving surface of said cutting table; and
wherein said spacer hole of said cutting table further comprises a hole there through said cutting table, preventing accumulation of matter within said spacer hole.

2. The sheet material cutting apparatus of claim 1 wherein said cutting guard and said cutting table are integrated into a single component disposed about said cutting surface of said cutter.

3. The sheet material cutting apparatus of claim 1 further comprising a cut piece separator disposed between said cutting table and said cutting surface guard.

4. The sheet material cutting apparatus of claim 3 wherein said cutting guard and said cutting table and said cut piece separator are integrated into a single component disposed about said cutting surface of said cutter.

5. The sheet material cutting apparatus of claim 1 further comprising a second cutter laterally displaced from first said cutter.

6. The sheet material cutting apparatus of claim 5 used to remove seams from the sheet material.

7. The sheet material cutting apparatus of claim 1 further comprising an upright mobility device wherein said cutter is disposed on said upright mobility device.

8. The sheet material cutting apparatus of claim 7 further comprising a cut line indicator disposed on said upright mobility device.

9. The sheet material cutting apparatus of claim 7 wherein said upright mobility device further comprises:
a carriage for accommodating said cutter;
a pair of axially aligned rearward wheels which are axially rotatably connected to said carriage and at least one forward wheel that is swivelably and rotatably mounted to said carriage, each said wheel being rotatably engagable with the surface of the sheet material;
said carriage including a support frame for accepting said cutter;
a handle attached to and extending rearwardly from said frame, whereby applying a generally horizontal pushing or pulling force to said handle causes said upright mobility device to move over the sheet material on said wheels while said cutter and said cutting table are maintained in a generally engaged condition with respect to the sheet material;
at least one of said wheels being carried by a strut that is connected to said frame, said strut being alternatable between an open condition wherein said wheel attached to said strut is deployed for moving on the sheet material and a collapsed condition wherein said wheel attached to said strut is retracted for storage of said mobility device; and
a hand switch to control operation of said cutter.

10. The sheet material cutting apparatus of claim 1 used to cut culvert liners.

11. The sheet material cutting apparatus of claim 1 used to cut stud liners.

12. The sheet material cutting apparatus of claim 1 used to cut a material selected from the group of materials consisting essentially of: plastic sheets, cardboard, corrugated board, tarps, metal sheets, and stud liner sheets.

13. A method for cutting sheet material comprising the steps of:
selectively receiving the sheet material to be cut, said selective receiving step comprising a guard means to restrict receipt of undesired objects;
tabling the sheet material received, said tabling step comprising a biasing means to prevent cutting of objects not selectively received;
cutting the sheet material received into at least two components; and
laterally displacing said at least two components of the sheet material.

14. The method of claim 13 wherein said cutting step comprises cutting the sheet material received along two substantially parallel lines, cutting the sheet material into three components.

15. The method of claim 14 used to remove seams from the sheet material.

16. The method of claim 13 further comprising the steps of:
disposing said cutting step near the elevation of the sheet material to be cut; and
operating and directing said cutting step from a position elevated from the elevation of the sheet material to be cut.

17. The method of claim 13 used to cut culvert liners.

18. The method of claim 13 used to cut stud liners.

19. The method of claim 13 used to cut a material selected from the group of materials consisting essentially of: plastic sheets, cardboard, corrugated board, tarps, metal sheets, and stud liner sheets.

20. A system for cutting sheet material comprising:
a means for cutting the sheet material, said cutting means comprising a cutting surface;
a means for guarding access to said cutting surface, disposed about said cutting surface, said guarding means comprising an opening for receiving the sheet material;
a means for tabling the sheet material, disposed about said cutting surface of said cutting means; said tabling means comprising a surface for receiving the material for cutting, said surface of said tabling means having a spacer hole preventing contact of the cutting surface of said cutting means with objects not received by said tabling means, said spacer hole being a hole there through, preventing accumulation of matter within said spacer hole; and
a means for separating pieces cut from the sheet material, said separating means having a surface for laterally displacing the pieces of the cut material.

21. The system of claim 20 further comprising a second means for cutting the sheet material, laterally displaced from first said cutting means.

22. The system of claim 21 used to remove seams from the sheet material.

23. The system of claim 20 further comprising a means to indicate a cut line.

24. The system of claim 20 further comprising:
a means to dispose said cutting means near the elevation of the sheet material to be cut; and
a means to operate and direct movement of the system from a position elevated from the elevation of the sheet material to be cut.

25. The system of claim 24 wherein:
said means to dispose said cutting means near the elevation of the sheet material to be cut comprises:
a carriage means for accommodating said cutting means;
a movable engagement means for moving said cutting means about the surface of the sheet material; and
said means to operate and direct movement of the system from a position elevated from the elevation of the sheet material to be cut comprises:
a support frame on said carriage means for accepting said cutting means;
a handle means attached to and extending rearwardly from said frame, whereby applying a generally horizontal pushing or pulling force to said handle means causes said disposing means to move over the sheet material on said movable engagement means while said cutting means and said tabling means are maintained in a generally engaged condition with respect to the sheet material;
at least one portion of said movable engagement means being carried by a strut that is connected to said frame, said strut being alternatable between an open condition wherein said movable engagement means attached to said strut is deployed for moving on the sheet material and a collapsed condition wherein said movable engagement means attached to said strut is retracted for storage of said disposing means; and
said handle means further comprising a hand switch to control operation of the cutting means.

26. The system of claim 20 used to cut culvert liners.

27. The system of claim 20 used to cut stud liners.

28. The system of claim 20 used to cut a material selected from the group of materials consisting essentially of: plastic sheets, cardboard, corrugated board, tarps, metal sheets, and stud liner sheets.
